(19) United States
(12) Patent Application Publication
(10) Pub. No.: US 2025/0292398 A1
(43) Pub. Date: Sep. 18, 2025

(54) SYSTEM AND METHOD FOR RECOGNITION OF ONE OR MORE HERBS

(71) Applicant: Logistics and Supply Chain MultiTech R&D Centre Limited, Pok Fu Lam (HK)

(72) Inventors: Chi Hung Tong, Pok Fu Lam (HK); King Loong Tse, Pok Fu Lam (HK); Yuk Yu Lau, Pok Fu Lam (HK)

(21) Appl. No.: 18/606,245

(22) Filed: Mar. 15, 2024

(51) Int. Cl. G06T 7/00

(52) U.S. Cl. CPC G06T 7/0012; G06T 2207/20081; G06T 2207/30188

(57) ABSTRACT

A system for recognition of one or more herbs including: an image gateway arranged to receive an input dataset including one or more images, each image showing one or more herbs, a classification engine arranged to: process the input image by identifying at least one herb of the one or more herbs, group the identified herb into at least one predefined class, wherein the predefined class corresponds to a type of herb, perform feature extraction on the input image to extract image features, predict the type of herb based on processing the extracted image features, and; an output module arranged to output the type of herb recognised in the image based on the combination of grouping into a predefined class and predicting the type of herb from the extracted features.

### TECHNICAL FIELD

The present invention relates to a system and method for recognition of one or more herbs. In particular, the present invention relates to a system and method for recognition of one or more herbs used in traditional Chinese Medicine (TCM) formulation.

### BACKGROUND

Traditional Chinese Medicine (TCM) is a health and wellness system developed in China. The system was developed in ancient China and is still practiced today in China and other parts of the world. TCM practitioners use various psychological and/or physical approaches to address health problems. One of the basic tenets is that the body's qi is circulating through channels called meridians having branches connected to bodily organs and functions. TCM generally includes a variety of therapies such as acupuncture, cupping therapy, gua sha, massage (e.g., tui na), qigong or tai chi, dietary therapy, and herbal medicine.

Herbal medicine is an important aspect of TCM. TCM herbal medicine practice includes use of plant elements as well as non-botanic substances such as animal fungi, mineral products etc. There are several thousand compounds used and over 100,000 TCM recipes or formulations recorded. TCM practitioners (i.e., TCM clinicians) dispense various herbal formulations. These formulations comprise one or more TCM compounds (i.e., herbs) that are processed in appropriate ways.

It is challenging to recognise or identify TCM formulations by eye. This can make it challenging for a TCM practitioner to correctly identify the one or more herbs used in TCM preparation. Many herbs that form constituents of a TCM formulation can often look similar to each other. This can be especially true after a herb has been processed to form a herbal formulation.

Some computer models have been developed to assist with automated recognition of one or more herbs e.g., herbs that may form part of a TCM formulation. A key challenge with any computer model is the large number of Chinese medicine classes. With over 600 classes each with unique visual characteristics and properties, it is very challenging for computer models to accurately distinguish between the various herbal formulations that form constituents of a TCM. Each class can relate to a specific herb or herbal formulation. The challenge is further exacerbated by the fact that many herbs that form constituents of a TCM formulation can vary in appearance depending on factors such as location of origin, processing methods and environmental factors.

### SUMMARY OF THE INVENTION

In accordance with a first aspect, the present invention provides a system for recognition of one or more herbs comprising:
an image gateway arranged to receive an input dataset comprising one or more images, each image showing one or more herbs,
a classification engine arranged to:
   process the input image by identifying at least one herb of the one or more herbs,
   group the identified herb into at least one predefined class, wherein the predefined class corresponds to a type of herb,
   perform feature extraction on the input image to extract image features,
   predict the type of herb based on processing the extracted image features, and;
an output module arranged to output the type of herb recognised in the image based on the combination of grouping into a predefined class and predicting the type of herb from the extracted features.

In one example configuration the classification engine comprises applying a multiclass single label image classification model to recognise the type of herb and output the recognised herb.

At least an embodiment of the invention has the advantage that system that improves the probability of predicting the correct herb that may be used in a TCM formulation. The system is advantageous as it can classify TCM herbs even with a large number of possible classes. The system integrates two or more types of models e.g., computer models that can process the input images and identify a herb e.g., a herb used in TCM formulations.

In one example configuration the classification engine is configured to group the identified herbs into multiple tier hierarchical classification.

In one example configuration the classification engine comprises a grouping module adapted to:
identifying a parent class and at least one sub class for the identified herb, and group the identified herb into the parent class and the at least one sub class.

In one example configuration the grouping module is adapted to first identify a parent class from a plurality of parent classes and subsequently identify a sub class from a plurality of sub classes within the identified parent class, and wherein the herb is grouped into the identified sub class.

In one example configuration the system further comprises an inference module adapted to process the input image received from the image gateway by applying an inference process to the received image showing one or more herbs to infer a herb in the image.

In one example configuration the grouping module is adapted to apply a Multimodal AI model to processing the input image and grouping the identified herb.

In one example configuration each parent class comprises between 40 and 80 sub classes. The parent class may comprise at least one sub class, but preferably a plurality of sub classes.

For example, the parent class may include a top-level classification category e.g., grass, root, seed, flower, fruit, leaf shell, animal and so on. Alternatively, the parent class may be as broad as plant material or non-botanic material.

In one example configuration the identified herb is initially grouped into one of ten predefined parent classes and one of 60 predefined sub classes.

In one example configuration the classification engine comprises a prediction module adapted to perform feature extraction and predict the type of herb.

In one example configuration the prediction module is configured to utilise an EfficientNet model for feature extraction and prediction.

In one example configuration the prediction module is further adapted to:
compare the extracted features with a set of predefined features corresponding to a predefined sub class,
determine the correct predefined sub class based on a substantial matching the extracted image features to the set of predefined features,
classify the herb into the determined predefined sub class, and;
wherein the type of herb is identified when the predefine sub class from the predicting step and the group step are substantially identical.

In one example configuration the classification engine may comprise a model that utilises a combined Multimodal AI model and an EfficientNet model.

In accordance with a second aspect, the present invention provides a computer implemented method for recognition of one or more herbs comprising the steps of:
receiving an input dataset comprising one or more images, each image showing one or more herbs,
processing the input image by identifying at least one herb of the one or more herbs,
grouping the identified herb into at least one predefined class, wherein the predefined class corresponds to a type of herb,
performing feature extraction on the input image to extract image features,
predicting the type of herb based on processing the extracted image features,
outputting the type of herb recognised in the image based on the combination of grouping into a predefined class and predicting the type of herb from the extracted features.

In one example the step of grouping the identified herb comprises grouping the identified herbs into multiple tier hierarchical classification.

In one example the step of grouping the identified herb comprises identifying a parent class and at least one sub class for the identified herb.

In one example the step of grouping comprises first identifying a parent class from a plurality of parent classes and subsequently identifying a sub class from a plurality of sub classes within the identified parent class, and wherein the herb is grouped into the identified sub class.

In one example the method further comprises processing the input image by applying an inference process to the received image showing one or more herbs to infer a herb in the image.

In one example the steps of processing the input image and grouping the identified herb are performed by a Multimodal AI model.

In one example each parent class comprises between 40 and 80 sub classes. In another example the identified herb is initially grouped into one of ten predefined parent classes and one of 60 predefined sub classes.

In one example the steps of feature extraction and predicting the type of herb are performed by utilizing an EfficientNet model.

In one example the step of predicting the type of herb from the extracted image features comprises:
comparing the extracted features with a set of predefined features corresponding to a predefined sub class,
determining the correct predefined sub class based on a substantial matching the extracted image features to the set of predefined features,
classifying the herb into the determined predefined sub class, and;
   wherein the type of herb is identified when the predefine sub class from the predicting step and the group step are substantially identical.

In one example the method is implemented by a Multiclass Single Label Image classification model.

According to one aspect, the present invention provides a machine-learning model for recognition of one or more herbs used in a TCM formulation, in particular for use in the method described above, comprising Multiclass Single Label Image classification model.

In one example the classification engine may comprise a machine learning model that comprises a convolution layer, a rectifier linear unit (ReLu) feeding into the convolution layer, a pooling layer downstream of the convolution layer and a fully connected layer downstream of the pooling layer. The outputs of the pooling layer may be flattened and fed into the fully connected layer. The fully connected layer outputting a herb recognised by the machine learning model when an input image is fed into the convolution layer.

In one example the present the method as described herein may be used to identify one or more herbs used in a TCM formulation.

According to a further aspect, the present invention provides a data processing apparatus comprising a processing unit for carrying out the method as described above or as defined in the claims.

According to a further aspect, the present invention provides a computer program comprising instructions which, when the program is executed by a computer, cause the computer to carry out the method as described above or as defined in the claims.

According to a further aspect, the present invention provides a computer-readable medium comprising instructions which, when executed by a computer, cause the computer to carry out the method as described above or as defined in the claims.

According to a further aspect, the present invention provides a computer-implemented method for recognition of one or more herbs comprising:
receiving an input dataset comprising one or more images, wherein each image showing at least one herb in the image,
identifying the at least one herb within each image,
classifying the at least one herb into a multi-level hierarchy and;
producing an identity of the herb based on the classification of the herb into an appropriate category.

The term “herb” or “herbal formulation” may cover a single herb or a mixture of multiple herbs. The term “herb” or “herbal formulation” includes plant elements as well as non-botanic substances such as animal products, fungi, mineral products, or other non-plant (i.e., non-botanic) products or element, that may be used in the preparation of TCM formulations. These herbs may be processed in any suitable manner e.g., grinding, cutting, shredding, powdering etc, to create a herbal formulation. A TCM formulation may comprise one or more herbs i.e., combination of plant elements and non-botanic substances. Herbs as defined above may form ingredients (i.e., constituents) of a TCM formulation.

Additionally, the term “herbs” or “herbal” also refers to Chinese medicinal compounds, or any materials or substances suitable for use in TCM practice, or medicinal compounds, or any materials or substances suitable for use in any therapeutic or dietary treatments or programs. Such therapeutic or dietary treatments or programs are not limited to TCM practice but may include other types of traditional or modern medicinal practice, health and well-being, dietary or psychology or psychiatry programs or treatments, as well as treatments for humans or veterinary treatment for animals. The compounds, materials or substances may also be in an unprocessed formed (e.g. picked plant or fungi materials, cut from animals, etc), semi-processed form (lightly processed materials that have been cut, dried or preserved, etc), in a processed form (medicinal compounds processed in powder form, pellet form, tablet form, or mixed with other compounds or materials, etc), or any combination of the above.

The term “comprising” (and its grammatical variations) as used herein are used in the inclusive sense of “having” or “including” and not in the sense of “consisting only of”.

It is to be understood that, if any prior art information is referred to herein, such reference does not constitute an admission that the information forms a part of the common general knowledge in the art, in any country.

### BRIEF DESCRIPTION OF THE DRAWINGS

Embodiments of the present invention will now be described, by way of example, with reference to the accompanying drawings in which:

FIG. 1 illustrates a diagram of the hardware components of a system for recognition of one or more herbs used in a TCM formulation.

FIG. 2 illustrates a schematic diagram of a system for recognition of one or more herbs used in a TCM formulation.

FIG. 3 illustrates an example method for recognition of one or more herbs used in a TCM formulation.

FIG. 4 illustrates a diagram of an example computer model that may be implemented by the computer or server.

FIG. 5 illustrates a further example method for recognition of one or more herbs used in a TCM formulation.

### DETAILED DESCRIPTION OF THE PREFERRED EMBODIMENTS

One of the key challenges in using AI or a computer model for TCM (Traditional Chinese Medicine) recognition is the large number of Chinese Medicine (CM) classes. With over 600 classes, each with unique characteristics and properties, it is difficult for AI models to accurately distinguish between the various classes and identify the specific herbs used in TCM formulations. Many herbs used for TCM formulations can vary in appearance depending on factors such as processing methods, environmental factors, origin etc. For example, sweet almond and bitter almond can look very similar after they are sliced into slices. It can be very challenging to distinguish between herbs e.g., between sweet almond and bitter almond by eye or even by a computer model.

Commonly used AI models for image recognition can struggle to recognise herbs used in TCM formulations due to the large number of herbs i.e., many herb classes and the variation in the herbs. Object detection databases such as for example, a YOLO model or algorithm can struggle with datasets that have many classes, especially when the classes i.e., herbs are visually similar. In TCM with over 600 classes of TCM herbs, many of which may share visual characteristics, a YOLO network can have difficulty in distinguishing between these hers accurately. Additionally, other networks can be difficult to train as the training dataset needs to be very large and diverse to cover all 600 plus classes with enough variability e.g., various quantities, patterns, and scenarios. Creating such datasets can be costly and time consuming, making it less practical to use computer models or AI models to recognise herbs used in TCM formulations.

In one example embodiment there is provided a computer implemented method for recognition of one or more herbs comprising the steps of: receiving an input dataset comprising one or more images, each image showing one or more herbs, processing the input image by identifying at least one herb of the one or more herbs, grouping the identified herb into at least one predefined class, wherein the predefined class corresponds to a type of herb, performing feature extraction on the input image to extract image features, predicting the type of herb based on processing the extracted image features, and; outputting the type of herb recognised in the image based on the combination of grouping into a predefined class and predicting the type of herb from the extracted features.

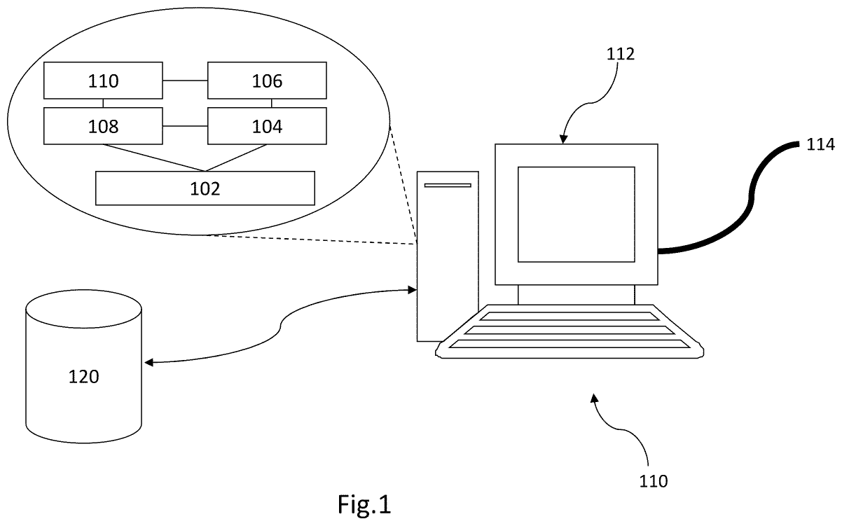

Referring to FIG. 1, an embodiment of the present invention is illustrated. This embodiment is arranged to provide a system and method for recognition of one or more herbs used in traditional Chinese Medicine (TCM) formulation. In one example embodiment there is provided a system for recognition of one or more herbs comprising: an image gateway arranged to receive an input dataset comprising one or more images, each image showing one or more herbs, a classification engine arranged to: process the input image by identifying at least one herb of the one or more herbs; group the identified herb into at least one predefined class, wherein the predefined class corresponds to a type of herb; perform feature extraction on the input image to extract image features; predict the type of herb based on processing the extracted image features, and; an output module arranged to output the type of herb recognised in the image based on the combination of grouping into a predefined class and predicting the type of herb from the extracted features.

In one example configuration the classification engine comprises applying a multiclass single label image classification model to recognise the type of herb and output the recognised herb. In one example configuration the classification engine may comprise a model that utilises a combined Multimodal AI model and an EfficientNet model.

In this example embodiment, the interface and processor are implemented by a computer having an appropriate user interface. The computer may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the invention.

In this embodiment, the system for recognition of one or more herbs can accurately recognise and identify one or more herbs used in a TCM formulation from one or more input images. The system may utilise a classification-based computer model (or AI model) for correctly recognising one or more herbs by processing input images. The classification-based model is arranged to use hierarchical classification of identified herbs in an image and then use feature extraction to further confirm and correctly recognise a herb in the input image.

As shown in FIG. 1 there is a shown a schematic diagram of a computer system or computer server 100 which is arranged to be implemented as an example embodiment of a system for recognition of one or more herbs, in particular a system for recognition of one or more herbs used in TCM formulations. In this embodiment the system comprises a computer or computing device e.g., a server 100 which includes suitable components necessary to receive, store and execute appropriate computer instructions. The components may include a processing unit 102, including Central Processing Unit (CPU), Math Co-Processing Unit (Math Processor), Graphic Processing Unit (GPUs) or Tensor Processing Unit (TPUs) for tensor or multi-dimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114. The server 100 may include instructions that may be included in ROM 104, RAM 106, or disk drives 108 and may be executed by the processing unit 102. There may be provided a plurality of communication links 114 which may variously connect to one or more computing devices such as a server, personal computers, terminals, wireless or handheld computing devices, Internet of Things (IOT) devices, smart devices, edge computing devices. At least one of a plurality of communications link may be connected to an external computing network through a telephone line or other type of communications link.

The computer e.g., the server 100 may include storage devices such as a disk drive 108 which may encompass solid state drives, hard disk drives, optical drives, magnetic tape drives or remote or cloud-based storage devices 120. The computer 100 may use a single disk drive or multiple disk drives, or a remote storage service. The server 100 may also have a suitable operating system which resides on the disk drive or in the ROM of the server 100.

The computer or computing apparatus (i.e., the server 100) may also provide the necessary computational capabilities to operate or to interface with a machine learning network, such as a neural network, to provide various functions and outputs. The neural network may be implemented locally, or it may also be accessible or partially accessible via a server or cloud-based service. The machine learning network may also be untrained, partially trained or fully trained, and/or may also be retrained, adapted, or updated over time. The server 100 may preferably implement a classification-based AI model that can process input images e.g., photos to recognise i.e., identify one or more herbs used in TCM formulations.

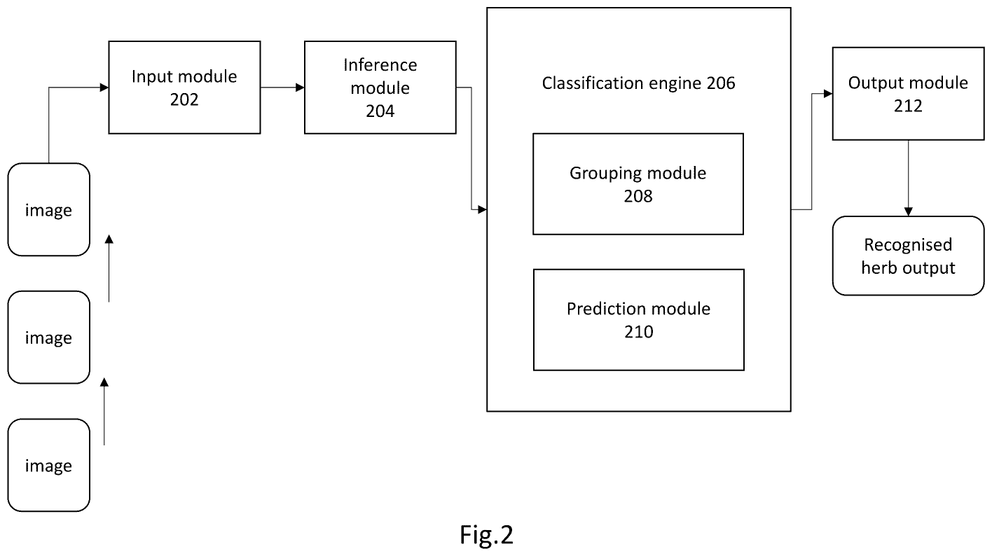

FIG. 1 illustrates an example hardware architecture used as part of a system for recognition of one or more herbs. Referring to FIG. 2 there is shown a system 200 for recognition of one or more herbs used in TCM formulations. In this embodiment the computer or server 100 is used as part of the system 200 or used to implement the system 200. The components and elements illustrated in FIG. 2 may be implemented as software modules or hardware modules within the server 100.

Referring to FIG. 2, the system 200 comprises an image gateway 202 adapted to receive an input dataset. The input dataset may comprise one or more images and each image showing one or more herbs. The herbs may be herbs used in a TCM formulation. The images may be captured by a camera. The captured images may be received at the computer 100 and image gateway 202 remotely or via a wired connection e.g., a USB input. The images may be serially processed or may be processed in parallel. In FIG. 2, the images are serially processed, as they are received at the image gateway.

The image gateway 202 may be configured to perform some preprocessing such as for example filtering and denoising of the received images. The image gateway 202 may collate the pre-processed images.

The system 200 comprises an inference module 204 adapted to process the input image received from the image gateway by applying an inference process to the received image showing one or more herbs to infer a herb in the image.

The system 200 comprises a classification engine 206. The classification engine 206 is arranged to: process the input image by identifying at least one herb of the one or more herbs, group the identified herb into at least one predefined class, wherein the predefined class corresponds to a type of herb, perform feature extraction on the input image to extract image features, predict the type of herb based on processing the extracted image features, and; an output module arranged to output the type of herb recognised in the image based on the combination of grouping into a predefined class and predicting the type of herb from the extracted features.

The classification engine 206 comprises a grouping module 208. The grouping module 208 may be adapted to identifying a parent class and at least one sub class for the identified herb and group the identified herb into the parent class and the at least one sub class. In one example configuration the grouping module may apply a Multimodal AI model to processing the input image and grouping the identified herb.

The grouping module 208 may classify the identified herb into multiple hierarchical classes. The grouping module 208 is adapted to first identify a parent class from a plurality of parent classes and subsequently identify a sub class from a plurality of sub classes within the identified parent class, and wherein the herb is grouped into the identified sub class.

The parent class may include a top-level classification category e.g., grass, root, seed, flower, fruit, leaf shell, animal and so on. Alternatively, the parent class may be as broad as plant material or non-botanic material. In one example configuration the identified herb is initially grouped into one of ten predefined parent classes and one of 60 predefined sub classes.

As shown in the example form in FIG. 2, the classification engine 206 comprises a prediction module 210 adapted to perform feature extraction and predict the type of herb. In one example the prediction module 210 is adapted to first compare the extracted features with a set of predefined features corresponding to a predefined sub class. The prediction module 210 is further configured to determine the correct predefined sub class based on a substantial matching the extracted image features to the set of predefined features. Once the correct predefined sub class is determined the prediction module 210 is configured to classify the herb into the determined predefined sub class. The type of herb is identified when the predefine sub class from the predicting step and the group step are substantially identical.

In one example configuration the prediction module is configured to utilise an EfficientNet model for feature extraction and prediction. The classification engine 206 may comprise a single model that combines Multimodal learning or a Multimodal AI model that provides hierarchical classification and an EfficientNet model.

The system 200 further comprises an output module 212 arranged to output the type of herb recognised in the image based on the combination of grouping into a predefined class and predicting the type of herb from the extracted features. The output recognition may be presented on the display 112 or may be transmitted to a remote system.

In one example configuration the classification engine comprises applying a multiclass single label image classification model to recognise the type of herb and output the recognised herb. The multiclass single label image classification model may comprise the components of the classification engine 204 described above.

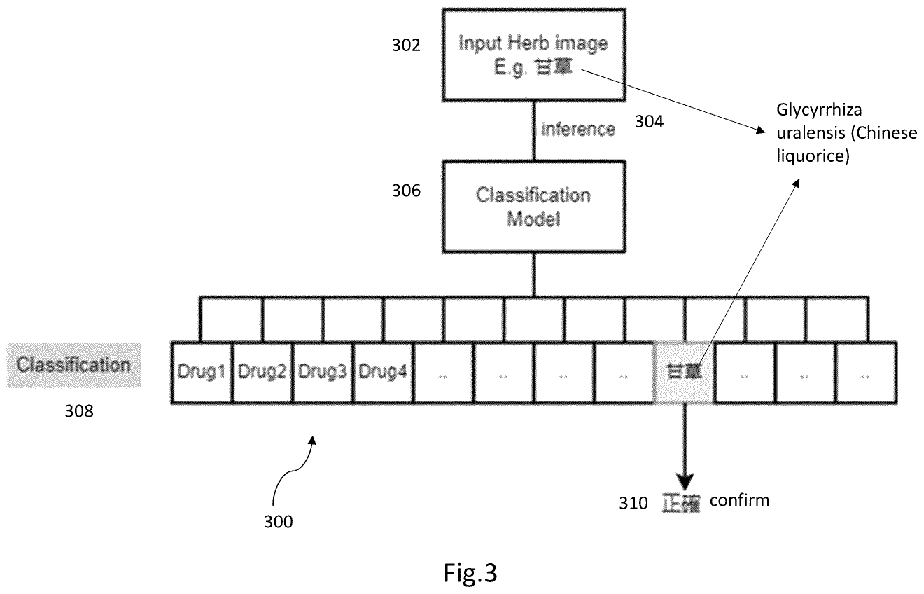

FIG. 3 illustrates an method 300 for recognition of one or more herbs. The method 300 may be implemented by the system 200 and the hardware components of the computer or server 100 described in reference to FIG. 1. Referring to FIG. 3, an input image is received at step 302. The input image shows one or more herbs. In the illustrated example, the input image shows an image of Glycyrrhiza uralensis (Chinese Liquorice). This is a herb used in some TCM formulations.

Step 304 comprises processing the input image by applying an inference process to the received image showing Chinese Liquorice. The inference process is adapted to infer a herb in the image e.g., Chinese Liquorice.

Step 306 comprises applying a classification model within the classification engine 206. The classification model may be a Multiclass Single Label Image classification model. The classification model may include processing the image by the grouping module 208 and prediction module 210.

Step 308 comprises classification of the identified herbs within the image. Step 308 comprises grouping the identified herb into at least one predefined class, wherein the predefined class corresponds to a type of herb and performing feature extraction on the input image to extract image features. Classification at step 308 further comprises predicting the type of herb based on processing the extracted image features. As shown in FIG. 3, the classification step classifies the identified herb into a predefined class.

The predefined class may be a child class which is a second level class. For example, the model may classify an identified herb initially into one of ten parent classes. The parent classes may be high level classifications e.g., grass, root, seeds, flower, fruit, leaf, animal product and so on. Each parent class may include sixty child classes. Each child class may correspond to a specific herb.

In an alternative form, the classification model may define three levels of classes, a parent class, child class and grandchild class. the parent class may be binary plant material or non-botanic material. A child class may be a broader category e.g., one of ten classes. A grandchild class may be associated with a specific child class. Each parent class may comprise multiple child classes e.g., 10 child classes. Each child class may include multiple grandchild classes e.g., 60 grandchild classes.

At step 308 multimodal analysis may be the backbone network used for hierarchical classification through visual reasoning. Once the correct grouping is identified e.g., the correct parent class, an EfficientNet model may be used for feature extraction from visual inputs to make a prediction of the target herb e.g., Chinese medicine herb.

Step 310 comprises outputting the identified herb. The identified herb may be displayed on the display 112. The system and method for recognition of one or more herbs can also be used to detect impurities. The classification engine 206 may be configured to detect impurities in a herb or a TCM formulation.

Open set classification is a problem of handling “unknown” classes that are not contained in a training dataset. Traditional classifiers assume that only known classes appear in a test environment. Multimodal AI or a Multimodal model is used in the classification engine to identify impurities such as a piece of a stapler inside a selected herb or TCM formulation. The feature extraction portion i.e., the computer vision algorithms can be used to analyse the images of herbs and identify foreign objects or abnormalities. This can help ensure the safety and quality of TCM formulations for patients.

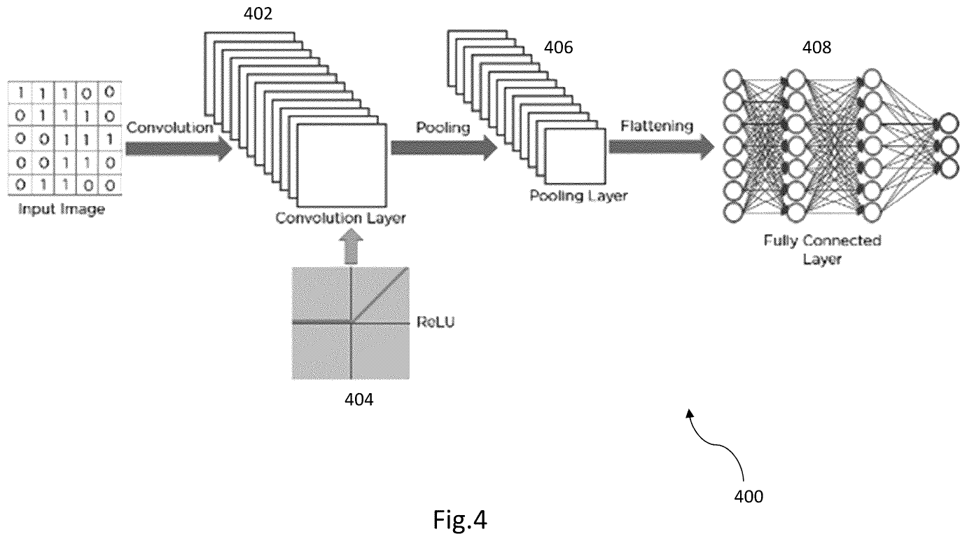

FIG. 4 illustrates an example computer model e.g., an AI model or machine learning model that may be implemented by the computer or server 100. The classification engine 206 is adapted to apply the illustrated computer model 400.

The computer model 400 may comprise a Multiclass Single Label Image classification model. Referring to FIG. 4, the model comprises a convolution layer 402. The convolution layer 402 is adapted to receive the input image 10 and apply convolutions to the input image. A ReLu 404 (Rectifier Linear Unit) is an activation function that is applied to the convolution layer 402. The outputs of the convolution layer 402 are pooled in a pooling layer 406. The pooling layer 406 is connected to the convolution layer 402. The pooling layer 406 is positioned downstream of the convolution layer 402. The model 400 comprises a fully connected layer 408. The outputs of the pooling layer 406 are flattened and provided to the fully connected layer 408. The output of the fully connected layer 408 may be presented to the user. The output may be the recognised herb in the one or more images.

The specific algorithm used by the model 400 may be a convolution neural network. The machine learning framework may be PyTorch. The specific detection feature in the model 400 may be an EfficientNet-B5 model. The resolution of the model may be 456. The final output may be converted to an ONNX model prior to presenting to the user. The output may be presented on the display 112.

Multimodal AI model as used herein is advantageous because it combines visual information with other data modalities. The Multimodal AI model may process visual information e.g. images and may output text e.g., the specific recognised herb. Optionally, text descriptions may also be provided with the input images. The text descriptions can provide information of the TCM herb properties and uses while the image data can help identify the unique compounds such as colour, shape, type, and size. Incorporating outputs from Multimodal help to break down 600 plus Chinese Medicine classes into smaller hierarchical classification, which increases the probability of predicting the correct TCM herb.

Hierarchical classification involves breaking down the classification task into a series of smaller, more manageable sub tasks. The hierarchical approach used in the present invention is advantageous as it helps to reduce the complexity of the task and improve the accuracy of the model. The system and method as per the present invention provide an improved way to detect i.e., recognise one or more herbs from images of herbs.

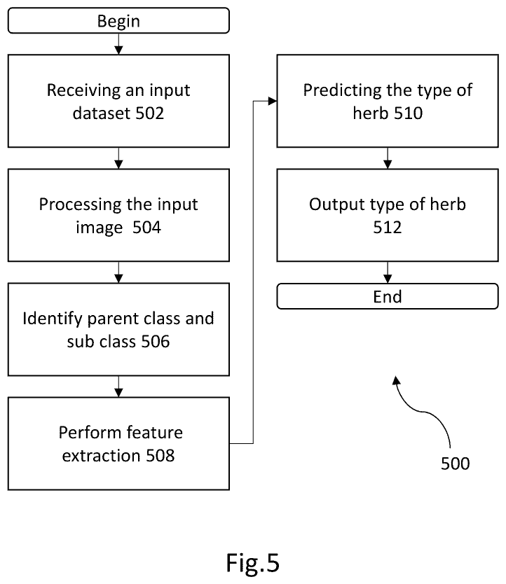

FIG. 5 illustrates another example method 500 for recognition of one or more herbs, e.g., one or more herbs used in a TCM formulation. The method commences at step 502. Step 502 comprises receiving an input dataset comprising one or more images, each image showing one or more herbs. Step 504 comprises processing the input image by applying an inference process to the received image showing one or more herbs to infer a herb in the image.

The method comprises grouping the identified herb into a predefined class. Step 506 comprises first identifying a parent class from a plurality of parent classes and subsequently identifying a sub class from a plurality of sub classes within the identified parent class. Each parent class comprises between 40 and 80 sub classes. In another example the identified herb is initially grouped into one of ten predefined parent classes and one of 60 predefined sub classes.

Step 508 comprises performing feature extraction on the input image to extract image features. Step 510 comprises predicting the type of herb based on processing the extracted image features.

In one example the step 510 of predicting the type of herb from the extracted image features may comprise comparing the extracted features with a set of predefined features corresponding to a predefined sub class, determining the correct predefined sub class based on a substantial matching the extracted image features to the set of predefined features, and classifying the herb into the determined predefined sub class. The type of herb is identified when the predefine sub class from the predicting step and the group step are substantially identical.

Step 512 comprises outputting the type of herb recognised in the image based on the combination of grouping into a predefined class and predicting the type of herb from the extracted features. The method 500 may be repeated each time an image is received. The method 500 may be continuously performed.

The method 500 is advantageous as it provides an improved identification of a herb from one or more images. Further the method uses a combination of hierarchical classification and image analysis i.e., feature extraction together to correctly recognise or identify a herb e.g., a herb used in TCM formulations. This results in a more efficient and effective method for recognition of a herb out of a potential 600 plus herbs that can be used in TCM formulations.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components, and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A system for recognition of one or more herbs comprising:
an image gateway arranged to receive an input dataset comprising one or more images, each image showing one or more herbs,
a classification engine arranged to:
process the input image by identifying at least one herb of the one or more herbs,
group the identified herb into at least one predefined class, wherein the predefined class corresponds to a type of herb,
perform feature extraction on the input image to extract image features,
predict the type of herb based on processing the extracted image features, and;
an output module arranged to output the type of herb recognised in the image based on the combination of grouping into a predefined class and predicting the type of herb from the extracted features.

2. A system for recognition of one or more herbs of claim 1, wherein the classification engine is configured to group the identified herbs into multiple tier hierarchical classification.

3. A system for recognition of one or more herbs of claim 2, wherein the classification engine comprises a grouping module adapted to:
identifying a parent class and at least one sub class for the identified herb, and
group the identified herb into the parent class and the at least one sub class.

4. A system for recognition of one or more herbs of claim 3 wherein the grouping module is adapted to first identify a parent class from a plurality of parent classes and subsequently identify a sub class from a plurality of sub classes within the identified parent class, and wherein the herb is grouped into the identified sub class.

5. A system for recognition of one or more herbs of claim 4, comprising an inference module adapted to process the input image received from the image gateway by applying an inference process to the received image showing one or more herbs to infer a herb in the image.

6. A system for recognition of one or more herbs of claim 4, wherein the grouping module is adapted to apply a Multimodal AI model to processing the input image and grouping the identified herb.

7. A system for recognition of one or more herbs of claim 6, wherein each parent class comprises between 40 and 80 sub classes.

8. A system for recognition of one or more herbs of claim 6, wherein the identified herb is initially grouped into one of ten predefined parent classes and one of 60 predefined sub classes.

9. A system for recognition of one or more herbs of claim 8, wherein the classification engine comprises a prediction module adapted to perform feature extraction and predict the type of herb.

10. A system for recognition of one or more herbs of claim 9, wherein the prediction module is configured to utilise an EfficientNet model for feature extraction and prediction.

11. A system for recognition of one or more herbs of claim 9, wherein the prediction module is further adapted to:
compare the extracted features with a set of predefined features corresponding to a predefined sub class,
determine the correct predefined sub class based on a substantial matching the extracted image features to the set of predefined features,
classify the herb into the determined predefined sub class, and;
wherein the type of herb is identified when the predefine sub class from the predicting step and the group step are substantially identical.

12. A system for recognition of one or more herbs of claim 1, wherein the classification engine comprises applying a multiclass single label image classification model to recognise the type of herb and output the recognised herb.

13. A computer implemented method for recognition of one or more herbs comprising the steps of:
receiving an input dataset comprising one or more images, each image showing one or more herbs,
processing the input image by identifying at least one herb of the one or more herbs,
grouping the identified herb into at least one predefined class, wherein the predefined class corresponds to a type of herb,
performing feature extraction on the input image to extract image features,
predicting the type of herb based on processing the extracted image features,
outputting the type of herb recognised in the image based on the combination of grouping into a predefined class and predicting the type of herb from the extracted features.

14. A computer implemented method for recognition of one or more herbs of claim 13, comprises the step of grouping the identified herb comprises grouping the identified herbs into multiple tier hierarchical classification.

15. A computer implemented method for recognition of one or more herbs of claim 14, wherein the step of grouping the identified herb comprises identifying a parent class and at least one sub class for the identified herb.

16. A computer implemented method for recognition of one or more herbs of claim 15, wherein the step of grouping comprises first identifying a parent class from a plurality of parent classes and subsequently identifying a sub class from a plurality of sub classes within the identified parent class, and wherein the herb is grouped into the identified sub class.

17. A computer implemented method for recognition of one or more herbs of claim 16, wherein the method comprises processing the input image by applying an inference process to the received image showing one or more herbs to infer a herb in the image.

18. A computer implemented method for recognition of one or more herbs of claim 16, wherein the steps of processing the input image and grouping the identified herb are performed by a Multimodal AI model.

19. A computer implemented method for recognition of one or more herbs of claim 16, wherein each parent class comprises between 40 and 80 sub classes.

20. A computer implemented method for recognition of one or more herbs of claim 19, wherein the identified herb is initially grouped into one of ten predefined parent classes and one of 60 predefined sub classes, and wherein the steps of feature extraction and predicting the type of herb are performed by utilizing an EfficientNet model and, wherein the step of predicting the type of herb from the extracted image features comprises:
comparing the extracted features with a set of predefined features corresponding to a predefined sub class,
determining the correct predefined sub class based on a substantial matching the extracted image features to the set of predefined features,
classifying the herb into the determined predefined sub class, and;
wherein the type of herb is identified when the predefine sub class from the predicting step and the group step are substantially identical, and wherein the method is implemented by a multiclass single label image classification model.
